(19) United States
(12) Patent Application Publication
(10) Pub. No.: US 2023/0161888 A1
(43) Pub. Date: May 25, 2023

(54) INFORMATION PROCESSING APPARATUS, NON-TRANSITORY COMPUTER READABLE MEDIUM STORING INFORMATION PROCESSING PROGRAM, AND INFORMATION PROCESSING METHOD

(71) Applicant: FUJIFILM Business Innovation Corp., Tokyo (JP)

(72) Inventor: Hiroki HONJO, Kanagawa (JP)

(73) Assignee: FUJIFILM Business Innovation Corp., Tokyo (JP)

(21) Appl. No.: 17/747,966

(22) Filed: May 18, 2022

(30) Foreign Application Priority Data
Nov. 19, 2021 (JP) 2021-188965

(51) Int. Cl. G06F 21/60; G06F 21/31

(52) U.S. Cl. CPC G06F 21/604; G06F 21/31; G06F 2221/2141

(57) ABSTRACT

An information processing apparatus includes a processor configured to: receive a change of an authority in one image forming apparatus among plural image forming apparatuses in which an authority is set for each role assigned to a user; and in a case where the change of the authority in the one image forming apparatus is applied to another image forming apparatus, and a predetermined condition is satisfied, reflect the received change of the authority to the other image forming apparatus.

### CROSS-REFERENCE TO RELATED APPLICATIONS

This application is based on and claims priority under 35 USC 119 from Japanese Patent Application No. 2021-188965 filed Nov. 19, 2021.

### BACKGROUND

### (i) Technical Field

The present invention relates to an information processing apparatus, a non-transitory computer readable medium storing an information processing program, and an information processing method.

### (ii) Related Art

JP1999-031019A (JP-H11-031019) discloses an information processing system including an execution unit, a storing unit, a designation unit, and a setting unit. The execution unit executes a process in a range permitted based on a setting authority range set for a user logged into the system. The storing unit stores authority information indicating a settable authority range for each user. The designation unit designates a change of the authority range of the user in the range of the settable authority range indicated by the authority information. The setting unit sets the authority range designated by the designation unit as a setting authority range in the execution unit.

### SUMMARY

In an image forming system configured by a plurality of image forming apparatuses, an operation of setting an authority to each role assigned to a user such that each image forming apparatus complies with predetermined conditions (security policy, and the like) in the image forming system from the viewpoint of security is performed.

In the image forming apparatus, in a case where the required authority is not set for the role assigned to the user, control of enabling a change of the authority for the role by selecting the required authority from a predetermined authority range may be performed.

However, in a case where the authority setting is changed in each image forming apparatus, the authority setting may differ between the image forming apparatuses, and thus the management of the authority settings of a plurality of image forming apparatuses forming the image forming system may be complicated.

Aspects of non-limiting embodiments of the present disclosure relate to an information processing apparatus, a non-transitory computer readable medium storing an information processing program, and an information processing method for facilitating management of authority settings of a plurality of image forming apparatus forming an image forming system, in comparison to a case of managing the authority setting for each image forming apparatus.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus includes a processor configured to: receive a change of an authority in one image forming apparatus among a plurality of image forming apparatuses in which an authority is set for each role assigned to a user; and in a case where the change of the authority in the one image forming apparatus is applied to another image forming apparatus, and a predetermined condition is satisfied, reflect the received change of the authority to the other image forming apparatus.

### BRIEF DESCRIPTION OF THE DRAWINGS

Exemplary embodiment(s) of the present invention will be described in detail based on the following figures, wherein:

FIG. 1 is a schematic diagram illustrating an example of a configuration of an information processing system according to each exemplary embodiment;

FIG. 2 is a block diagram illustrating an example of a hardware configuration of an information processing apparatus in each exemplary embodiment;

FIG. 3 is a block diagram illustrating an example of a functional configuration of the information processing apparatus in each exemplary embodiment;

FIG. 4 is a diagram illustrating an example of authority information set in the image forming apparatus in each exemplary embodiment;

FIG. 5 is a diagram illustrating an example of role information set in the image forming apparatus in each exemplary embodiment;

FIG. 6 is a diagram illustrating an example of function information set in the image forming apparatus in each exemplary embodiment;

FIG. 7 is a diagram illustrating an example of the function information provided for explaining a change of an authority in each exemplary embodiment;

FIG. 8 is a flowchart illustrating an example of a process of changing the authority according to a first exemplary embodiment;

FIG. 9 is a flowchart illustrating an example of a process of reflecting the authority in the first exemplary embodiment;

FIG. 10 is a flowchart illustrating an example of a process of changing an authority according to a second exemplary embodiment;

FIG. 11 is a diagram illustrating an example of role information provided for explaining a change of a role according to a third exemplary embodiment; and

FIG. 12 is a flowchart illustrating an example of a process of changing an authority in the third exemplary embodiment.

### DETAILED DESCRIPTION

### First Exemplary Embodiment

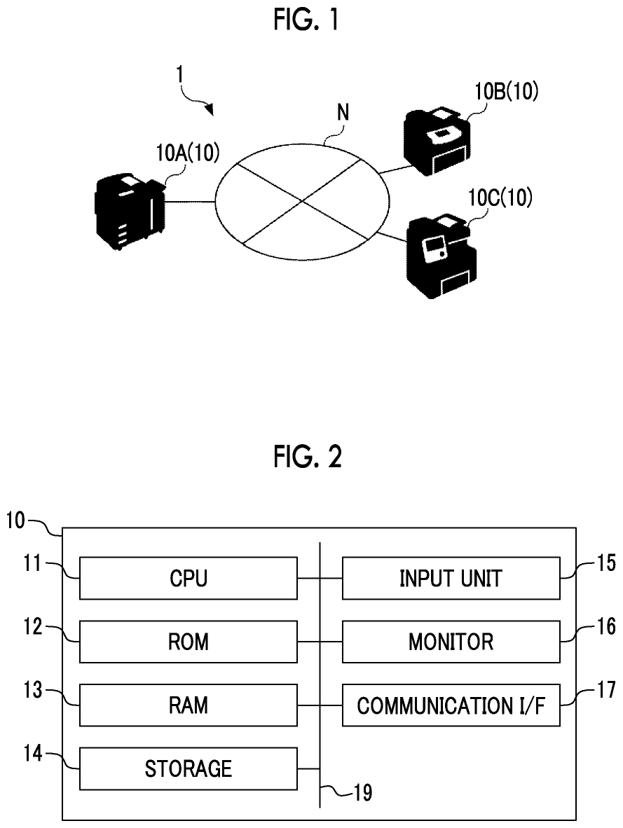

Hereinafter, exemplary embodiments for carrying out the present invention will be described in detail with reference to the drawings. FIG. 1 is a schematic diagram illustrating an example of a configuration of an information processing system 1 according to the present exemplary embodiment.

As an example, as illustrated in FIG. 1, the information processing system 1 is configured such that image forming apparatuses functioning as a copying machine 10A, a printer machine 10B, and a scanner machine 10C are connected to each other via a network N. In the present exemplary embodiment, a form in which an information processing apparatus 10 is mounted on each image forming apparatus forming the information processing system 1 will be described. The present exemplary embodiment is not limited to such a form. The information processing apparatus 10 may be mounted on a server (not illustrated).

The information processing apparatus 10 functions as each image forming apparatus, and changes the registered user, the role assigned to the user, and the authority set for each role, and manages the authority in the information processing system 1. For example, in a case where the information processing apparatus 10 receives a change of an authority in an image forming apparatus that is the own machine (referred to as a “host apparatus” below), the information processing apparatus 10 reflects the received change of the authority to the other image forming apparatus (referred to as “the other apparatus” below). In the present exemplary embodiment, for example, descriptions will be made on the assumption that the copying machine 10A is the host apparatus, and the printer machine 10B and the scanner machine 10C are the other apparatuses. Here, the host apparatus is an example of “one image forming apparatus”, and the other apparatus is an example of “the other image forming apparatus”.

The information processing apparatus 10 determines whether or not a predetermined condition such as a security policy is satisfied in a case where a change of an authority in the host apparatus and a change of an authority in the other apparatus are reflected, and the change of the authority has been applied. In a case where the predetermined condition is satisfied, the information processing apparatus 10 performs control of reflecting the change of the authority to the host apparatus and the other apparatus and manages the authority in the information processing system 1.

Here, the predetermined condition refers to, for example, a case where, by changing the authority, all authorities in the image forming apparatus to which the change is reflected are not aggregated to any of roles set in the image forming apparatus. In other words, the predetermined condition refers to a case where all the authorities are not set for one role by changing the authority in the image forming apparatus.

Next, a hardware configuration of the information processing apparatus 10 will be described below with reference to FIG. 2. FIG. 2 is a block diagram illustrating an example of the hardware configuration of the information processing apparatus 10 according to the present exemplary embodiment.

As illustrated in FIG. 2, the information processing apparatus 10 in the present exemplary embodiment includes a central processing unit (CPU) 11, a read only memory (ROM) 12, a random access memory (RAM) 13, a storage 14, an input unit 15, a monitor 16, and a communication interface (communication I/F) 17. Each of the CPU 11, the ROM 12, the RAM 13, the storage 14, the input unit 15, the monitor 16, and the communication I/F 17 are connected to each other by a bus 19. Here, the CPU 11 is an example of a processor.

The CPU 11 collectively controls the entirety of the information processing apparatus 10. The ROM 12 stores various programs including an information processing program used in the present exemplary embodiment, data, and the like. The RAM 13 is a memory used as a work area when executing various programs. The CPU 11 develops the program stored in the ROM 12 into the RAM 13 and executes the program to execute a process of changing the role and the authority. The storage 14 is, for example, a hard disk drive (HDD), a solid state drive (SSD), a flash memory, or the like. The information processing program and the like may be stored in the storage 14. The input unit 15 is a touch panel, a keyboard, or the like that receives an input of a text or the like. The monitor 16 displays texts and images. The communication I/F 17 transmits and receives data.

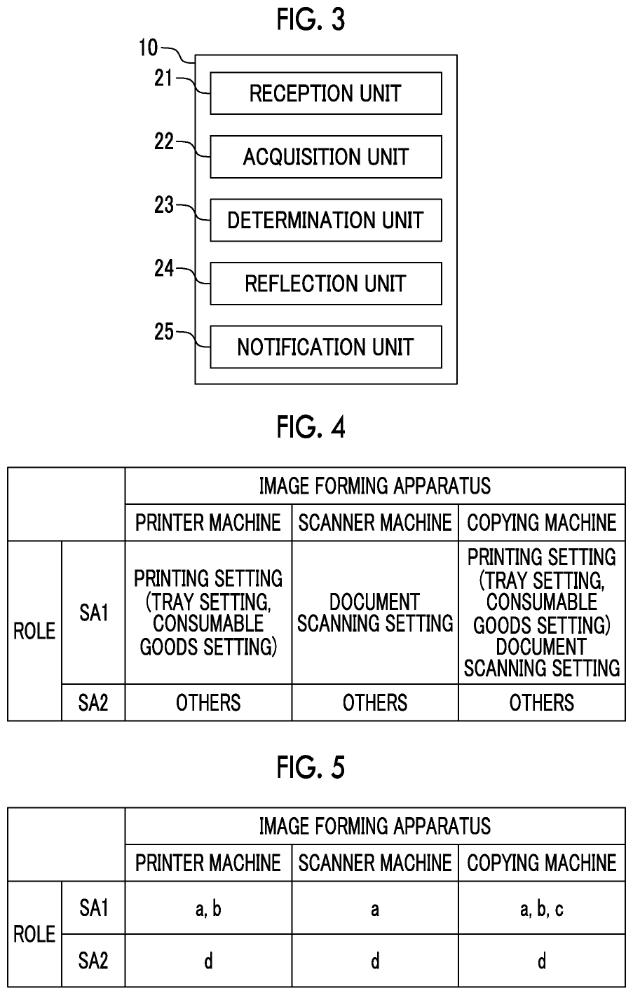

Next, the functional configuration of the information processing apparatus 10 will be described with reference to FIG. 3. FIG. 3 is a block diagram illustrating an example of the functional configuration of the information processing apparatus 10 in the present exemplary embodiment.

As illustrated in FIG. 3 as an example, the information processing apparatus 10 includes a reception unit 21, an acquisition unit 22, a determination unit 23, a reflection unit 24, and a notification unit 25. The information processing apparatus 10 functions as the reception unit 21, the acquisition unit 22, the determination unit 23, the reflection unit 24, and the notification unit 25 by the CPU 11 executing the information processing program.

The reception unit 21 receives changes of authority information and role information. Here, the authority information refers to information indicating the relationship between the role set in each image forming apparatus illustrated in FIG. 4 as an example and the authority set for the role. The role information refers to information indicating the relationship between the user registered in each image forming apparatus illustrated in FIG. 5 as an example and the role assigned to the user.

Specifically, the reception unit 21 receives an instruction to change the authority related to the authority information input by a worker who operates the image forming apparatus and an instruction to change the role related to the role information input by a worker who operates the image forming apparatus.

FIG. 4 is a diagram illustrating an example of the authority information set in the image forming apparatus in the present exemplary embodiment. As illustrated in FIG. 4 as an example, in the present exemplary embodiment, a system administrator (SA) 1 and SA2 are set as roles in each image forming apparatus. For example, in the printer machine, an authority for a printing setting is set for SA1, and all authorities other than the printing setting are set for SA2. Similarly, in the scanner machine, an authority for a document scanning setting is set for SA1, and all authorities other than the document scanning setting are set for SA2. In the copying machine, an authority for a printing setting and a document scanning setting is set for SA1, and all authorities other than the printing setting and the document scanning setting are set for SA2. In the present exemplary embodiment, a form in which the authority information related to each image forming apparatus is stored in the corresponding image forming apparatus will be described.

FIG. 5 is a diagram illustrating an example of the role information registered in the image forming apparatus in the present exemplary embodiment. As illustrated in FIG. 5 as an example, users a, b, and d are registered in the printer machine, users a and d are registered in the scanner machine, and users a, b, c, and d are registered in the copying machine. In the printer machine, SA1 is assigned as the role to a and b, and SA2 is assigned as the role to d. Similarly, in the scanner machine, SA1 is assigned as the role to a, and SA2 is assigned as the role to d. In the copying machine, SA1 is assigned as the role to a, b, and c, and SA2 is assigned as the role to d. In the present exemplary embodiment, a form in which the role information related to each image forming apparatus is stored in the corresponding image forming apparatus will be described.

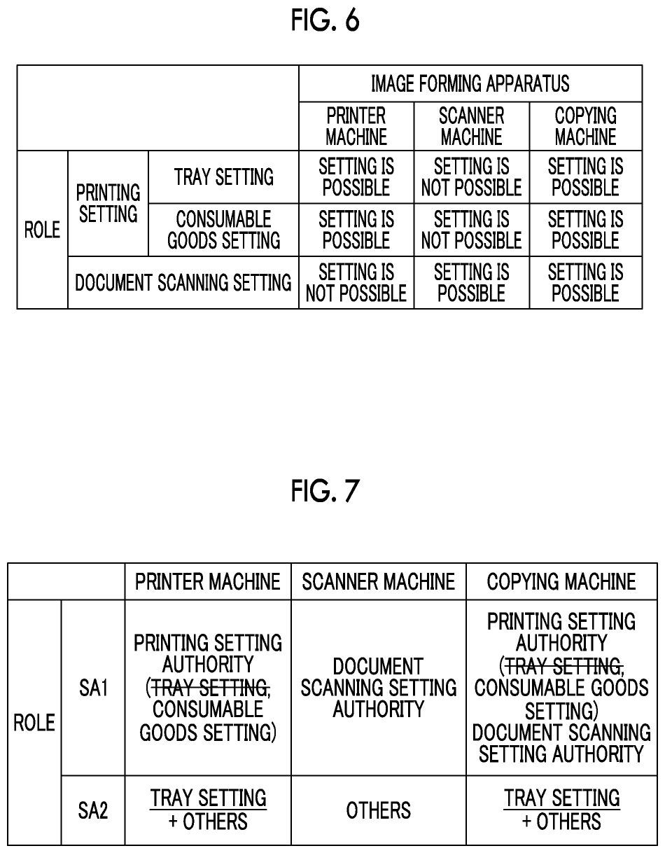

The acquisition unit 22 acquires the authority information, the role information, and the function information, which have been set, from each image forming apparatus. Here, the function information refers to information indicating a function for which setting of the authority is possible and which is executable in each image forming apparatus illustrated in FIG. 6 as an example.

FIG. 6 is a diagram illustrating an example of the function information as a function of each image forming apparatus. As illustrated in FIG. 6 as an example, in the present exemplary embodiment, the functions include a printing setting and a document scanning setting, and the printing setting includes a tray setting and a consumable goods setting. For example, in the printer machine, setting of the authority for the printing setting is possible. In the scanner machine, setting of the authority for the document scanning setting is possible. In the copying machine, setting of the authority for the printing setting and the document scanning setting is possible. In the present exemplary embodiment, a form in which the function information related to each image forming apparatus is stored in the corresponding image forming apparatus will be described.

The determination unit 23 determines whether or not a predetermined condition is satisfied in a case where the change of the authority information received by the reception unit 21 is applied to the host apparatus and the other apparatus. The determination unit 23 determines whether or not the user is assigned to the role set in the image forming apparatus in a case where the change of the role information received by the reception unit 21 is applied to the host apparatus and the other apparatus.

Here, the predetermined condition refers to a case where, by changing the authority in the authority information, all authorities in the image forming apparatus to which the change is reflected are not aggregated to any of roles set in the image forming apparatus, as described above.

The reflection unit 24 reflects the change of the authority information applied in the host apparatus to the other apparatus. Specifically, in a case where the change of the authority information is applied to the other apparatus, and the predetermined condition is satisfied, the reflection unit 24 reflects the change of the authority information changed in the host apparatus to the other apparatus.

In a case where the predetermined condition is not satisfied in each image forming apparatus, the reflection unit 24 does not reflect the change to the host apparatus and the other apparatus. Specifically, in a case where the received change of the authority information is applied to the host apparatus, and the predetermined condition is not satisfied, the reflection unit 24 does not change the authority information in the host apparatus. Further, in a case where the received change of the authority information is applied to the other apparatus, and the predetermined condition is not satisfied, the reflection unit 24 does not reflect the change of the authority information to the other apparatus.

In a case where the predetermined condition is not satisfied in the host apparatus and the other apparatus, the notification unit 25 issues a notification indicating that the predetermined condition is not satisfied. Specifically, in a case where the change of the authority information is applied to the host apparatus and the other apparatus, and the predetermined condition is not satisfied, the notification unit 25 issues a notification indicating that all authorities in the host apparatus and the other apparatus are set for one role. The notification according to the present exemplary embodiment is transmitted to the administrators of the host apparatus and the other apparatus, who have been registered in advance.

For example, as illustrated in FIG. 7 as an example, in a case where the reception unit 21 receives the change of the authority for the tray setting from SA1 to SA2 in the copying machine as the host apparatus, the acquisition unit 22 acquires authority information related to the copying machine. In a case where the authority for the tray setting is changed from SA1 to SA2 by using the acquired authority information related to the copying machine, the determination unit 23 determines whether or not all authorities in the copying machine are set for SA2. Here, in FIG. 7, the strikethrough attached to the authority indicates the authority deleted from the role, and the underline attached to the authority indicates the new authority set for the role. That is, the strikethrough and the underline in FIG. 7 indicate that the authority for the tray setting has been deleted from SA1, set for SA2, and the authority has been changed.

As illustrated in FIG. 7, in a case where the change of the authority for the tray setting from SA1 to SA2 is applied in the copying machine, the authority other than the consumable goods setting and the document scanning setting is assigned to SA2, and all authorities in the copying machine are not set. Therefore, the determination unit 23 determines that the predetermined condition is satisfied, and the reflection unit 24 changes the authority for the tray setting from SA1 to SA2 in the copying machine being the host apparatus.

In the copying machine, the change is performed in the host apparatus, and then, the acquisition unit 22 acquires the authority information related to the other apparatus to which applying the change is possible. Specifically, as illustrated in FIG. 6, regarding the changed authority for the tray setting, the acquisition unit 22 acquires the authority information related to the printer machine of which the similar setting is possible. In a case where the change of the authority for the tray setting, which has been changed in the copying machine being the host apparatus is applied to the printer machine being the other apparatus, the determination unit 23 determines whether or not the predetermined condition is satisfied.

As illustrated in FIG. 7, in a case where the change of the authority for the tray setting from SA1 to SA2 is applied in the printer machine, the authority other than the consumable goods setting is assigned to SA2, and all authorities in the printer machine are not set. Therefore, the determination unit 23 determines that the predetermined condition is satisfied, and the reflection unit 24 changes the authority for the tray setting from SA1 to SA2 in the printer machine being the other apparatus.

In a case where the authority for the consumable goods setting is further changed in the copying machine, and the change of the authority for the consumable goods setting is applied in the printer machine being the other apparatus, the determination unit 23 determines whether or not the predetermined condition is satisfied. As illustrated in FIG. 7, in a case where the authority for the consumable goods setting is further changed to SA2 in the printer machine, all the authorities in the printer machine are set for SA2, and thus the predetermined condition is not satisfied. Therefore, the determination unit 23 determines that the predetermined condition is not satisfied, and the notification unit 25 notifies the administrator registered in advance that all the authorities in the printer machine are set for SA2 by applying the change.

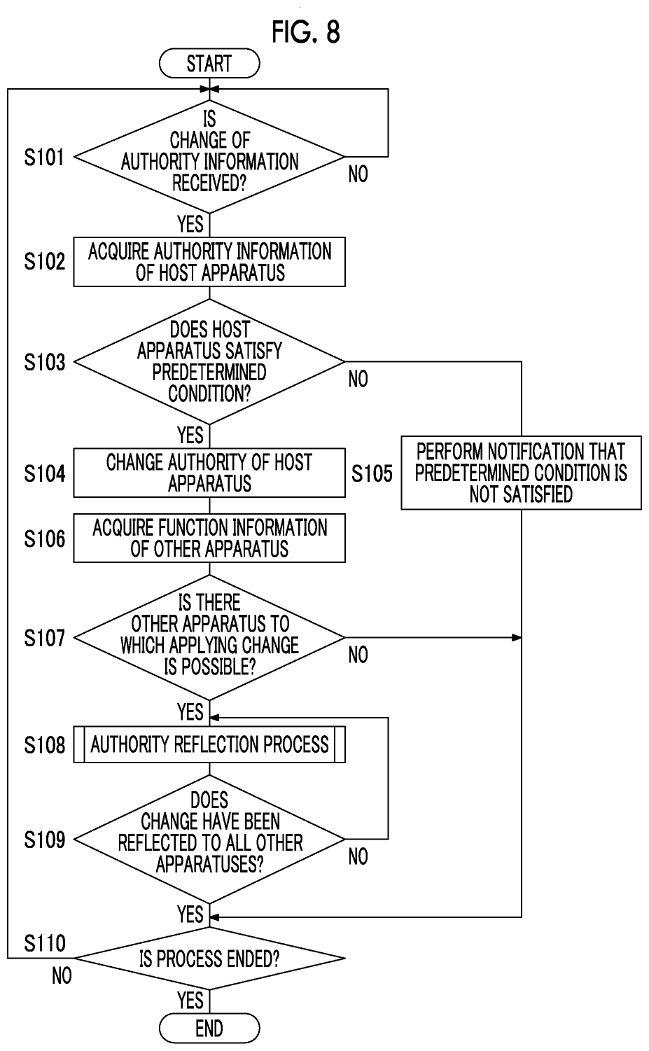

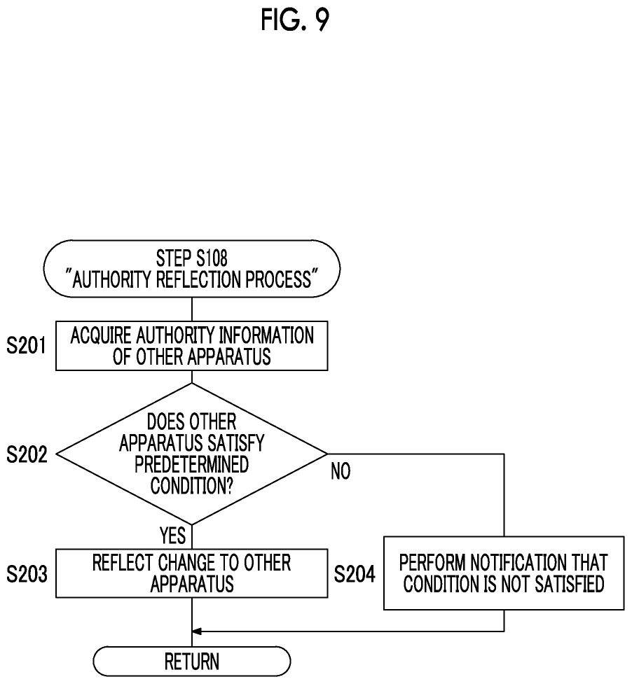

Next, the operation of the information processing apparatus 10 according to the present exemplary embodiment will be described with reference to FIGS. 8 and 9. FIG. 8 is a flowchart illustrating an example of a process of changing the authority information according to the present exemplary embodiment. An information process illustrated in FIG. 8 is executed by the CPU 11 reading out the information processing program from the ROM 12 or the storage 14 and executing the information processing program. The information process illustrated in FIG. 8 is executed, for example, in a case where an instruction to execute the process of changing the authority information is input.

In Step S101, the CPU 11 determines whether or not the change of authority information has been received from a worker. In a case where the change of the authority information has been received (Step S101: YES), the CPU 11 proceeds to Step S102. On the other hand, in a case where the change of the authority information is not received (Step S101: NO), the CPU 11 waits until the change of the authority information is received.

In Step S102, the CPU 11 acquires the authority information set in the host apparatus.

In Step S103, in a case where the change of the authority information is applied, the CPU 11 determines whether or not the host apparatus satisfies a predetermined condition. In a case where the host apparatus satisfies the predetermined condition (Step S103: YES), the CPU 11 proceeds to Step S104. On the other hand, in a case where the host apparatus does not satisfy the predetermined condition (Step S103: NO), the CPU 11 proceeds to Step S105.

In Step S104, the CPU 11 changes the authority information of the host apparatus by applying the change of the authority information received from the worker.

In Step S105, the CPU 11 notifies the administrator that the host apparatus does not satisfy the predetermined conditions.

In Step S106, the CPU 11 acquires function information set in the other apparatus, from the other apparatus forming the information processing system 1.

In Step S107, the CPU 11 determines, by using the acquired function information, whether or not there is the other apparatus to which applying the change of the authority information received from the worker is possible. In a case where there is the other apparatus to which applying the change of the authority information is possible (Step S107: YES), the CPU 11 proceeds to Step S108. On the other hand, in a case where there is no other apparatus to which applying the change of the authority information is possible (Step S107: NO), the CPU 11 proceeds to Step S110.

In Step S108, the CPU 11 executes an authority reflection process. The authority reflection process will be described in detail with reference to FIG. 9 described later.

In Step S109, the CPU 11 determines whether or not the change has been reflected to all the other apparatuses to which applying the change is possible. In a case where the change has been reflected to all the other apparatuses (Step S109: YES), the CPU 11 proceeds to Step S110. On the other hand, in a case where the change has not been reflected to all the other apparatuses (there is the other apparatus to which the change has not been reflected) (Step S109: NO), the CPU 11 proceeds to Step S108.

In Step S110, the CPU 11 determines whether or not to end the process. In a case where the process is ended (Step S110: YES), the CPU 11 ends the information process. On the other hand, in a case where the process is not ended (Step S110: NO), the CPU 11 proceeds to Step S101 and determines whether or not the change of the authority information has been received from the worker.

Next, the authority reflection process will be described with reference to FIG. 9. FIG. 9 is a flowchart illustrating an example of a process of reflecting the authority in the present exemplary embodiment. The authority reflection process illustrated in FIG. 9 is executed by the CPU 11 reading out an authority reflection program from the ROM 12 or the storage 14 and executing the authority reflection program. The authority reflection process illustrated in FIG. 9 is executed, for example, in a case where the change of the authority information is received from the user and an apparatus to which applying the change is possible is detected.

In Step S201, the CPU 11 acquires the authority information set in the other apparatus.

In Step S202, in a case where the change of the authority information is applied to the detected other apparatus, the CPU 11 determines whether or not the other apparatus satisfies the predetermined condition. In a case where the other apparatus satisfies the predetermined condition (Step S202: YES), the CPU 11 proceeds to Step S203. On the other hand, in a case where the other apparatus does not satisfy the predetermined condition (Step S202: NO), the CPU 11 proceeds to Step S204.

In Step S203, the CPU 11 transmits the change of the authority information, which has been received from the worker, to the other apparatus, and reflects the change of the authority information to the other apparatus.

In Step S204, the CPU 11 notifies the administrator that the other apparatus does not satisfy the predetermined conditions.

As described above, according to the present exemplary embodiment, it is possible to facilitate management of the authority setting of a plurality of image forming apparatuses forming the image forming system, in comparison to a case of managing the authority setting for each image forming apparatus.

### Second Exemplary Embodiment

In the first exemplary embodiment, a form in which the change of the authority information, which has been received from the worker, is reflected to the other apparatus has been described. In the present exemplary embodiment, a form in which, in a case where the authority information is not set in the other apparatus, the authority information of the host apparatus is reflected will be described.

The configuration (see FIG. 1) of the information processing system, the hardware configuration (see FIG. 2) of the information processing apparatus 10, and the functional configuration (see FIG. 3) of the information processing apparatus 10 according to the present exemplary embodiment are similar to the configuration, the hardware configuration, and the functional configuration in the first exemplary embodiment, and thus the description thereof will be omitted. Further, since the example (see FIG. 4) of the authority information, the example (see FIG. 5) of the role information, and the example (see FIG. 6) of the function information according to the present exemplary embodiment are similar to the examples in the first exemplary embodiment, and thus the description thereof will be omitted. Further, the example (see FIG. 7) of the authority information provided for explaining the change of the authority and the flowchart (see FIG. 8) illustrating the example of the information process according to the present exemplary embodiment are similar to the examples in the first exemplary embodiment, and thus the description thereof will be omitted.

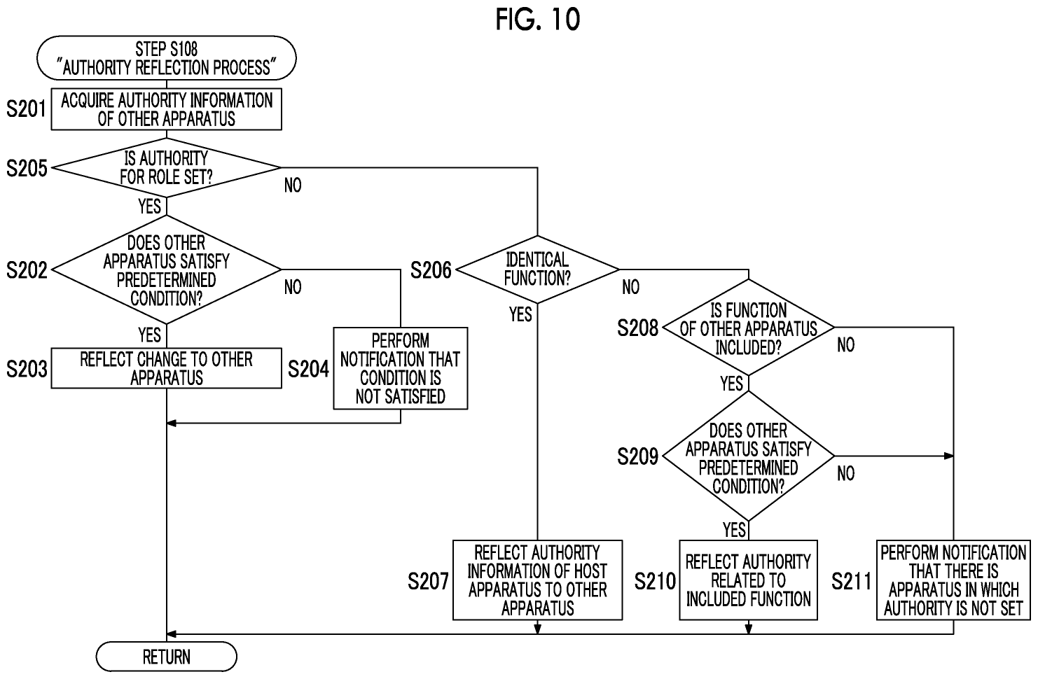

The authority reflection process will be described with reference to FIG. 10. FIG. 10 is a flowchart illustrating an example of the process of reflecting the authority in the present exemplary embodiment. The authority reflection process illustrated in FIG. 10 is executed by the CPU 11 reading out the authority reflection program from the ROM 12 or the storage 14 and executing the authority reflection program. The authority reflection process illustrated in FIG. 10 is executed, for example, in a case where the change of the authority information is received from the user and an apparatus to which applying the change is possible is detected. In FIG. 10, steps identical to the steps in the authority reflection process illustrated in FIG. 9 are denoted by the identical reference signs to FIG. 9, and the description thereof will be omitted.

In Step S205, the CPU 11 determines, by using the authority information in the other apparatus, whether or not the authority for the role is set in the other apparatus. In a case where the authority for the role is set (Step S205: YES), the CPU 11 proceeds to Step S202. On the other hand, in a case where the authority for the role is not set (Step S205: NO), the CPU 11 proceeds to Step S206.

In Step S206, the CPU 11 determines, by using the function information, whether or not setting the identical authority in the host apparatus and the other apparatus is possible, and the host apparatus and the other apparatus have the identical function. In a case where the host apparatus and the other apparatus have the identical function (Step S206: YES), the CPU 11 proceeds to Step S207. On the other hand, in a case where the host apparatus and the other apparatus do not have the identical function (Step S206: NO), the CPU 11 proceeds to Step S208.

In Step S207, the CPU 11 reflects the authority information set in the host apparatus to the other apparatus. Here, in the present exemplary embodiment, in a case where the authority information is not set in the other apparatus and the function of the host apparatus corresponds to the function of the other apparatus (includes the function of the other apparatus), the CPU 11 reflects the authority information related to this function in the host apparatus to the other apparatus.

For example, in a case where the host apparatus and the other apparatus are copying machines, the authority information in the copying machine being the host apparatus is reflected to the copying machine being the other apparatus. Further, in a case where the host apparatus is a copying machine and the other apparatus is a printer machine, the copying machine includes a function of the authority for the printing setting of which setting in the printer machine is possible. That is, since setting of the authority information of the printing setting similar to the printing setting of the copying machine is possible in the printer machine, the authority information of the printing setting of the copying machine is reflected to the printer machine, and the authority similar to the authority information of the printing setting installed on the copying machine is set in the printer machine.

In Step S208, the CPU 11 determines whether or not the function of the host apparatus includes the function of the other apparatus and the setting of some authorities set in the host apparatus is possible in the other apparatus. In a case where the function of the host apparatus includes the function of the other apparatus (Step S208: YES), the CPU 11 proceeds to Step S209. On the other hand, in a case where the function of the host apparatus does not include the function of the other apparatus (Step S208: NO), the CPU 11 proceeds to Step S211.

In Step S209, in a case where the authority information related to the function of the host apparatus corresponding to the function of the other apparatus is applied to the other apparatus, the CPU 11 determines whether or not the predetermined condition is satisfied. In a case where the other apparatus satisfies the predetermined condition (Step S209: YES), the CPU 11 proceeds to Step S210. On the other hand, in a case where the other apparatus does not satisfy the predetermined condition (Step S209: NO), the CPU 11 proceeds to Step S211.

In Step S210, the CPU 11 reflects the authority information related to the function of the host apparatus corresponding to the function of the other apparatus, to the other apparatus.

In Step S211, the CPU 11 notifies the administrator that there is an image forming apparatus in which the authority information has not been set.

As described above, according to the present exemplary embodiment, it is possible to more easily set the authority information in an image forming apparatus added later than in the case of setting the authority information for each image forming apparatus.

### Third Exemplary Embodiment

In the second exemplary embodiment, a form in which, in a case where the authority information is not set, the authority information of the host apparatus is reflected has been described. In the present exemplary embodiment, a form in which, in a case where a change of a user registered in the host apparatus is received from the worker, the change of the user is reflected to the other apparatus will be described.

The configuration (see FIG. 1) of the information processing system, the hardware configuration (see FIG. 2) of the information processing apparatus 10, and the functional configuration (see FIG. 3) of the information processing apparatus 10 according to the present exemplary embodiment are similar to the configuration, the hardware configuration, and the functional configuration in the first exemplary embodiment, and thus the description thereof will be omitted. Further, since the example (see FIG. 4) of the authority information, the example (see FIG. 5) of the role information, and the example (see FIG. 6) of the function information according to the present exemplary embodiment are similar to the examples in the first exemplary embodiment, and thus the description thereof will be omitted. Further, the example (see FIG. 7) of the authority information provided for explaining the change of the authority and the flowchart (see FIG. 9) illustrating the example of the authority reflection process according to the present exemplary embodiment are similar to the examples in the first exemplary embodiment, and thus the description thereof will be omitted.

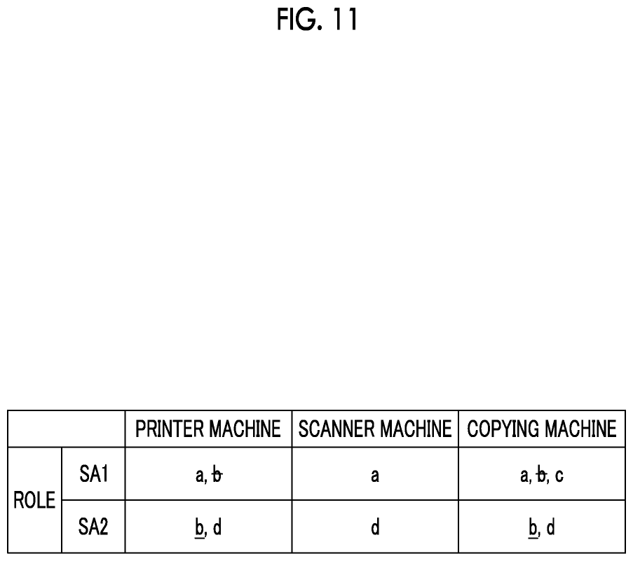

For example, as illustrated in FIG. 11 as an example, in a case where the reception unit 21 receives the change of the role of the user b from SA1 to SA2 in the copying machine as the host apparatus, the acquisition unit 22 acquires the role information registered in the copying machine. In a case where the role of the user b is changed from SA1 to SA2, the determination unit 23 determines whether or not there is a user assigned to SA1, by using the acquired role information. Here, in FIG. 11, the strikethrough attached to the registered user indicates that the role set for the user has been deleted, and the underline attached to the user indicates that a new role is set for the user. That is, the strikethrough and the underline in FIG. 11 indicate that SA1 set for the user b has been deleted, SA2 has been newly set for the user b, and the role has been changed.

As illustrated in FIG. 11, in a case where the change of the role of the user b from SA1 to SA2 is applied in the copying machine, SA1 is assigned to the users a and c. Therefore, the determination unit 23 determines that there is a user assigned to the role, and the reflection unit 24 changes the role of the user b from SA1 to SA2 in the host apparatus.

Further, in the copying machine, the change is performed in the host apparatus, and then, the acquisition unit 22 acquires the role information of the other apparatus. Specifically, as illustrated in FIG. 11, since the user b is registered in the printer machine, the acquisition unit 22 acquires the role information of the printer machine. In a case where the change of the role of the user changed in the host apparatus is applied to the printer machine being the other apparatus, the determination unit 23 determines whether or not there is a user assigned to the changed role.

Similarly, as illustrated in FIG. 11, in a case where the change of the role of the user from SA1 to SA2 is applied in the printer machine, there is a user assigned to SA1. Therefore, the determination unit 23 determines that there is the user assigned to the role, and the reflection unit 24 changes the role of the user b from SA1 to SA2 in the printer machine being the other apparatus.

That is, in a case where there is a user assigned to a role, the information processing apparatus 10 reflects the role information changed in the host apparatus to the other apparatus.

In a case where the role of the user a is further changed from SA1 to SA2 in the copying machine, and the change of the role of the user a is applied in the printer machine being the other apparatus, the determination unit 23 determines whether or not there is a user assigned to the role. As illustrated in FIG. 11, in a case where the role of the user a is further changed to SA2 in the printer machine, there is no user assigned to SA1. The reflection unit 24 changes the role of the user b from SA1 to SA2 in the printer machine being the other apparatus. The notification unit 25 notifies the administrator that there is no user assigned to SA1 in the printer machine by applying the change, and the setting of the role information is to be reviewed.

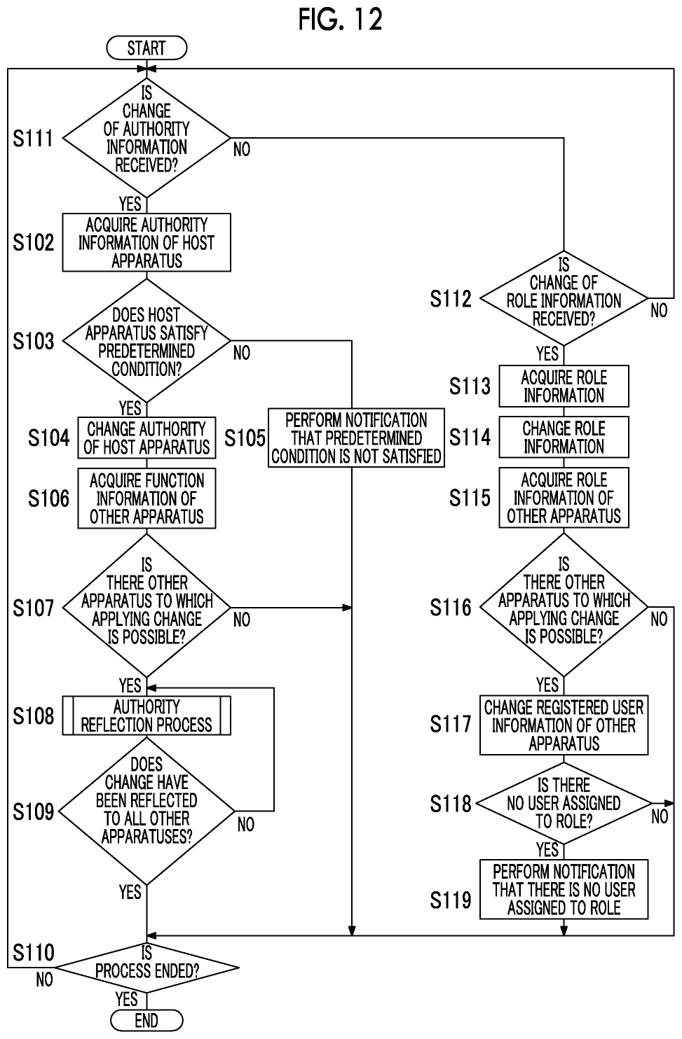

Next, the operation of the information processing apparatus 10 according to the present exemplary embodiment will be described with reference to FIG. 12. FIG. 12 is a flowchart illustrating an example of the process of changing the authority information according to the present exemplary embodiment. The information process illustrated in FIG. 12 is executed by the CPU 11 reading out the information processing program from the ROM 12 or the storage 14 and executing the information processing program. The information process illustrated in FIG. 12 is executed, for example, in a case where an instruction to execute the process of changing the authority information is input. In FIG. 12, steps identical to the steps in the process of changing the authority information illustrated in FIG. 8 are denoted by the identical reference signs to FIG. 8, and the description thereof will be omitted.

In Step S111, the CPU 11 determines whether or not the change of authority information has been received from a worker. In a case where the change of the authority information has been received (Step S111: YES), the CPU 11 proceeds to Step S102. On the other hand, in a case where the change of the authority information is not received (Step S111: NO), the CPU 11 proceeds to step S112.

In Step S112, the CPU 11 determines whether or not the change of the user and the role has been received from the worker. In a case where the change of the user and the role has been received (Step S112: YES), the CPU 11 proceeds to step S113. On the other hand, in a case where the change of the user and the role is not received (Step S112: NO), the CPU 11 proceeds to Step S111 and waits until the change of the authority information or the role information is received from the worker.

In Step S113, the CPU 11 acquires the role information set in the host apparatus.

In Step S114, the CPU 11 changes the role information of the host apparatus by applying the change of the role information received from the worker.

In Step S115, the CPU 11 acquires the role information set in the other apparatus.

In Step S116, the CPU 11 determines, by using the role information set in the other apparatus, whether or not there is the other apparatus to which applying the change of the role information received from the worker is possible. In a case where there is the other apparatus to which applying the change of the role information is possible (Step S116: YES), the CPU 11 proceeds to Step S117. On the other hand, in a case where there is no other apparatus to which applying the change of the role information is possible (Step S116: NO), the CPU 11 proceeds to Step S110.

In Step S117, the CPU 11 changes the role information of the other apparatus by applying the change of the role information received from the worker.

In Step S118, the CPU 11 determines whether or not there is a user assigned to the changed role in the other apparatus. In a case where there is no user assigned to the changed role (Step S118: YES), the CPU 11 proceeds to Step S119. On the other hand, in a case where there is the user assigned to the changed role (Step S118: NO), the CPU 11 proceeds to Step S110.

In Step S119, the CPU 11 notifies the administrator that there is no user assigned to the changed role in the other apparatus by applying the change of the role information, and the setting of the role is to be reviewed.

As described above, according to the present exemplary embodiment, it is possible to facilitate management of the role assigned to the user in a plurality of image forming apparatuses forming the image forming system in comparison to the case of managing the role assigned to the user by each image forming apparatus.

Hitherto, the present invention has been described above by using each exemplary embodiment, but the present invention is not limited to the scope described in each exemplary embodiment. Various changes or improvements may be made to each exemplary embodiment without departing from the gist of the present invention, and the changed or improved modes are also included in the technical scope of the present invention.

In the above exemplary embodiments, the form in which the authority information in the host apparatus is reflected to the other apparatus has been described. However, the present disclosure is not limited to the above form. The role information registered in the host apparatus may be reflected to the other apparatus.

Further, in the above exemplary embodiments, a form in which, in a case where the predetermined condition is not satisfied, the administrator registered in advance is notified has been described. However, the present disclosure is not limited to the above form. An operator who is operating the host apparatus may be notified. For example, in a case where the predetermined condition is not satisfied, the notification unit 25 may notify the operator by displaying, on the monitor 16, a message indicating that the predetermined condition is not satisfied.

Further, in the above exemplary embodiments, a form in which, in a case where the changed role is not assigned to the user, the administrator is notified that there is a role not assigned to the user has been described. However, the present disclosure is not limited to the above form. The operator who is operating the host apparatus may be notified. For example, in a case where there is a role not assigned to the user, the notification unit 25 may notify the operator by displaying, on the monitor 16, a message indicating that there is a role not assigned to the user.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

Further, in the present exemplary embodiment, a mode in which the information processing program is installed in the storage has been described, but the present exemplary embodiment is not limited to the mode. The information processing program according to the present exemplary embodiment may be provided in a mode in which the information processing program is recorded on a computer-readable storage medium. For example, the information processing program according to the exemplary embodiment of the present invention may be provided in a mode in which the information processing program is recorded on an optical disk such as a compact disc (CD)-ROM and a digital versatile disc (DVD)-ROM. The information processing program according to the exemplary embodiment of the present invention may be provided in a mode in which the information processing program is recorded in a semiconductor memory such as a universal serial bus (USB) memory and a memory card. Further, the information processing program according to the present exemplary embodiment may be acquired from an external apparatus via a communication line connected to the communication I/F.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
receive a change of an authority in one image forming apparatus among a plurality of image forming apparatuses in which an authority is set for each role assigned to a user; and
in a case where the change of the authority in the one image forming apparatus is applied to another image forming apparatus, and a predetermined condition is satisfied, reflect the received change of the authority to the other image forming apparatus.

2. The information processing apparatus according to claim 1, wherein the processor is configured to:
in a case where the predetermined condition is not satisfied, not reflect the change of the authority for the role in the other image forming apparatus.

3. The information processing apparatus according to claim 2, wherein the processor is configured to:
in a case where the predetermined condition is not satisfied, issue a notification indicating that the condition is not satisfied.

4. The information processing apparatus according to claim 1, wherein the processor is configured to:
further receive a change of the role assigned to the user in the one image forming apparatus, and
reflect the change of the role in the one image forming apparatus to the other image forming apparatus.

5. The information processing apparatus according to claim 2, wherein the processor is configured to:
further receive a change of the role assigned to the user in the one image forming apparatus, and
reflect the change of the role in the one image forming apparatus to the other image forming apparatus.

6. The information processing apparatus according to claim 3, wherein the processor is configured to:
further receive a change of the role assigned to the user in the one image forming apparatus, and
reflect the change of the role in the one image forming apparatus to the other image forming apparatus.

7. The information processing apparatus according to claim 4, wherein the processor is configured to:
in a case where the change of the role in the one image forming apparatus is applied to the other image forming apparatus, and there is no user assigned to the role in the other image forming apparatus, issue a notification indicating that the user does not exist.

8. The information processing apparatus according to claim 5, wherein the processor is configured to:
in a case where the change of the role in the one image forming apparatus is applied to the other image forming apparatus, and there is no user assigned to the role in the other image forming apparatus, issue a notification indicating that the user does not exist.

9. The information processing apparatus according to claim 6, wherein the processor is configured to:
in a case where the change of the role in the one image forming apparatus is applied to the other image forming apparatus, and there is no user assigned to the role in the other image forming apparatus, issue a notification indicating that the user does not exist.

10. The information processing apparatus according to claim 1,
wherein the predetermined condition is a case where all the authorities are not collectively set for any role in each of the image forming apparatuses.

11. The information processing apparatus according to claim 2,
wherein the predetermined condition is a case where all the authorities are not collectively set for any role in each of the image forming apparatuses.

12. The information processing apparatus according to claim 3,
wherein the predetermined condition is a case where all the authorities are not collectively set for any role in each of the image forming apparatuses.

13. The information processing apparatus according to claim 4,
wherein the predetermined condition is a case where all the authorities are not collectively set for any role in each of the image forming apparatuses.

14. The information processing apparatus according to claim 5,
wherein the predetermined condition is a case where all the authorities are not collectively set for any role in each of the image forming apparatuses.

15. The information processing apparatus according to claim 1, wherein the processor is configured to:
in a case where the change of the authority does not satisfy a condition similar to the predetermined condition in the one image forming apparatus, not perform the change of the authority for the one image forming apparatus.

16. The information processing apparatus according to claim 1, wherein the processor is configured to:
in a case where an authority for a role is not set in the other image forming apparatus, acquire information indicating a function of each of the one image forming apparatus and the other image forming apparatus, and
in a case where the function of the other image forming apparatus corresponds to the function of the one image forming apparatus, reflect the authority set for each role in the one image forming apparatus to the other image forming apparatus.

17. The information processing apparatus according to claim 16, wherein the processor is configured to:
in a case where the function of the one image forming apparatus includes the function of the other image forming apparatus, and the authority set for each role in the one image forming apparatus is applied to the other image forming apparatus, determine whether or not a condition similar to the predetermined condition is satisfied, and
in a case where the condition similar to the predetermined condition is satisfied, reflect the role and the authority corresponding to the function of the other image forming apparatus.

18. The information processing apparatus according to claim 16, wherein the processor is configured to:
in a case where the function of the other image forming apparatus does not correspond to the function of the one image forming apparatus, issue a notification indicating that the authority is not assigned for the role in the other image forming apparatus.

19. A non-transitory computer readable medium storing an information processing program causing a computer to execute a process comprising:
receiving a change of an authority in one image forming apparatus among a plurality of image forming apparatuses in which an authority is set for each role assigned to a user; and
in a case where the change of the authority in the one image forming apparatus is applied to another image forming apparatus, and a predetermined condition is satisfied, reflecting the received change of the authority to the other image forming apparatus.

20. An information processing method comprising:
receiving a change of an authority in one image forming apparatus among a plurality of image forming apparatuses in which an authority is set for each role assigned to a user; and
in a case where the change of the authority in the one image forming apparatus is applied to another image forming apparatus, and a predetermined condition is satisfied, reflecting the received change of the authority to the other image forming apparatus.
